(19) United States
(12) Patent Application Publication
(10) Pub. No.: US 2025/0337462 A1
(43) Pub. Date: Oct. 30, 2025

(54) METHOD AND APPARATUS FOR DESIGNING WMMSE BEAMFORMING MATRIX ROBUST TO CHANNEL ERRORS IN MU-MISO SYSTEMS

(71) Applicant: Korea University Research and Business Foundation, Seoul (KR)

(72) Inventors: In Kyu LEE, Seoul (KR); Min Seok KIM, Seoul (KR); WenTao ZHOU, Seoul (KR)

(21) Appl. No.: 18/867,776

(22) PCT Filed: Nov. 30, 2022
(86) PCT No.: PCT/KR2022/019170

§ 371 Date: Nov. 20, 2024

(30) Foreign Application Priority Data
Jun. 24, 2022 (KR) 10-2022-0077634

(51) Int. Cl. H04B 7/06

(52) U.S. Cl. CPC H04B 7/0617; H04B 7/0634; H04B 7/0652

(57) ABSTRACT

The present invention relates to a method and an apparatus for designing a WMMSE beamforming matrix robust to channel errors for MU-MISO systems. A method for transmitting signals from a base station in a communication system according to an embodiment of the present invention may include the steps of: receiving, from a mobile station, channel feedback information generated based on a channel between the base station and the mobile station; determining a beamforming matrix that maximizes the weighted sum rate (WSR) using the channel feedback information; and transmitting a signal to the mobile station based on the beamforming matrix, wherein the channel between the base station and the mobile station may consist a first component corresponding to the channel feedback information and a second component corresponding to a quantization error, and the beamforming matrix may be determined based on the second component corresponding to the quantization error.

### TECHNICAL FIELD

The present invention relates to a method and apparatus for designing a beamforming matrix in a wireless communication system, and more particularly, to a method and apparatus for designing a weighted minimum mean square error (WMMSE) beamforming matrix that is robust to channel errors in a multi-user multiple-input single output (MU-MISO) system.

### BACKGROUND ART

To improve the system throughput performance in wireless communication systems, multi-user (MU) multiple-input multiple-output (MIMO) or multi-user multiple-input single-output (MISO) techniques have been discussed. If the transmitter can perfectly identify the channel state information (CSI), which represents the channel state between the transmitter and receiver, the system's sum rate can be maximized through appropriately designed beamforming techniques. In particular, weighted minimum mean square error (WMMSE) beamforming is known as an excellent algorithm that can provide a locally optimal solution for the sum rate of multi-user systems. However, in practical wireless communications, the performance of beamforming design is significantly degraded in the presence of channel uncertainties. Therefore, when implementing practical wireless communications, it is necessary to design beamforming algorithms that can ensure excellent performance even in the presence of channel uncertainties. In particular, for frequency division duplex (FDD)-based multi-user systems, channel uncertainty primarily arises from quantization errors in the limited feedback process. Therefore, beamforming techniques need to be designed to compensate for the channel uncertainties resulting from these quantization errors in the limited feedback process.

### DISCLOSURE

### Technical Problem

The present invention proposes a method for designing a WMMSE beamforming matrix that is robust to channel errors and can compensate for channel uncertainty resulting from quantization errors in the limited feedback process, thereby maximizing the sum rate in a multi-user (MU) multiple-input single-output (MISO) system.

### Technical Solution

To accomplish the above object of the present invention, an embodiment of the present invention provides a method for transmitting signals from a base station in a communication system, the method comprising the steps of: receiving, from a mobile station, channel feedback information generated based on a channel between the base station and the mobile station; determining a beamforming matrix that maximizes the weighted sum rate (WSR) using the channel feedback information; and transmitting a signal to the mobile station based on the beamforming matrix, wherein the channel between the base station and the mobile station consists of a first component corresponding to the channel feedback information and a second component corresponding to a quantization error, and wherein the beamforming matrix is determined based on the second component corresponding to the quantization error.

Another embodiment of the present invention provides a base station apparatus for transmitting signals in a communication system, the base station apparatus comprising: a receiving unit for receiving, from a mobile station, channel feedback information generated based on a channel between a base station and the mobile station; a control unit for determining a beamforming matrix that maximizes the weighted sum rate (WSR) using the channel feedback information; and a transmitting unit for transmitting a signal to the mobile station based on the beamforming matrix, wherein the channel between the base station and the mobile station consists of a first component corresponding to the channel feedback information and a second component corresponding to a quantization error, and wherein the beamforming matrix is determined based on the second component corresponding to the quantization error.

### Effects of the Invention

The present invention can provide higher sum rate performance compared to existing beamforming techniques used in limited feedback communication systems.

### DESCRIPTION OF DRAWINGS

FIG. 1 is a diagram illustrating a wireless communication system based on a multi-user multiple-input single output (MU-MISO) according to an embodiment of the present invention.

FIG. 2 is a diagram illustrating a quantization error between an actual channel and a fed-back channel in a limited feedback system according to an embodiment of the present invention.

FIG. 3 is a flowchart illustrating the operation of a base station according to an embodiment of the present invention.

FIG. 4 is a flowchart illustrating a method for a base station to determine a beamforming matrix according to an embodiment of the present invention.

FIG. 5 is a diagram illustrating the configuration of a base station apparatus according to an embodiment of the present invention.

FIG. 6 is a diagram illustrating the ergodic convergence of a WMMSE beamforming algorithm according to an embodiment of the present invention.

FIG. 7 is a diagram illustrating an example of the comparison of sum rate performance between a RWMMSE beamforming algorithm according to an embodiment of the present invention and a conventional beamforming algorithm.

FIG. 8 is a diagram illustrating another example of the comparison of sum rate performance between the RWMMSE beamforming algorithm according to an embodiment of the present invention and a conventional beamforming algorithm.

### MODE FOR INVENTION

Hereinafter, embodiments of the present invention will be described in detail with reference to the accompanying drawings.

In describing the embodiments, descriptions of technical features that are well known in the art to which the present invention pertains and are not directly related to the present invention will be omitted. This is intended to convey the scope of the present invention more clearly without obscuring the gist of the present invention by omitting unnecessary descriptions.

For the same reason, some components in the accompanying drawings are exaggerated, omitted, or illustrated schematically. Moreover, the size of each component does not fully reflect the actual size. The same or corresponding components in each drawing are assigned the same reference numerals.

The advantages and features of the present invention, and the methods for achieving them, will become apparent with reference to the embodiments described in detail below, in conjunction with the accompanying drawings. However, the present invention is not limited to the embodiments disclosed below and may be implemented in various different forms. The embodiments are provided only to complete the disclosure of the present invention and to allow those skilled in the art to which the present invention pertains to fully understand the scope of the disclosure, and the present invention is defined only by the appended claims. The same reference numerals designate the same components throughout the specification. Moreover, when describing the present invention, if it is determined that detailed descriptions of related functions or configurations would unnecessarily obscure the gist of the present invention, the detailed descriptions will be omitted. Furthermore, the terms used herein are defined in view of their functions in the present invention and may vary depending on the intention or custom of users or operators. Therefore, their definitions should be interpreted based on the content throughout this specification.

As used herein, the term “base station” refers to the entity responsible for resource allocation to a mobile station and may include at least one of a gNode B (gNB), an eNode B (eNB), a Node B, a BS (Base station), a radio access unit, a base station controller, or a node on a network. The mobile station may comprise user equipment (UE), a mobile station (MS), a cellular phone, a smartphone, a computer, or a multimedia system capable of performing communication functions. As used herein, the term “downlink (DL)” refers to the wireless transmission path for signals transmitted from the base station to the mobile station, and the term “uplink (UL)” refers to the wireless transmission path for signals transmitted from the mobile station to the base station. Moreover, although Long-Term Evolution (LTE) or LTE-advanced (LTE-A) systems may be described as examples below, the embodiments of the present invention may also be applied to other communication systems with similar technical backgrounds or channel configurations. For example, the fifth generation mobile communication technology (5G, new radio, NR) developed after LTE-A may be included herein, and the term “5G” used below may encompass existing LTE, LTE-A, and other similar services. Furthermore, the present invention may also be applied to other communication systems through certain modifications, as determined by those skilled in the art, without departing from the scope of the present invention.

It will be understood that the blocks in the flowchart diagrams and their combinations can be executed by computer program instructions. These computer program instructions may be loaded onto a processor of a general-purpose computer, a special-purpose computer, or other programmable data processing equipment, so that the instructions executed by the processor of the computer or other programmable data processing equipment will create means for performing the functions described in the flowchart block(s).

These computer program instructions may also be stored in a computer-usable or computer-readable memory, which can be directed to a computer or other programmable data processing equipment to implement specific functionalities. Therefore, the instructions stored in the computer-usable or computer-readable memory can also produce an article of manufacture including instruction means for performing the functions described in the flowchart block(s). The computer program instructions can also be installed on a computer or other programmable data processing equipment, allowing a series of operational steps to be performed on the computer or other programmable data processing equipment to create a computer-executable process, so that these instructions can provide the steps for executing the functions described in the flowchart block(s).

In addition, each block may represent a module, segment, or portion of code that contains one or more executable instructions for performing the specified logical function(s). It should also be noted that, in some alternative implementation examples, the functions mentioned in the blocks may occur out of sequence. For example, two blocks that are shown consecutively may actually be performed substantially simultaneously, or the blocks may sometimes be executed in reverse order, depending on their respective functions.

The term “unit” as used herein refers to a software or hardware component such as a field programmable gate array (FPGA) or an application-specific integrated circuit (ASIC), and the “unit” performs certain roles. However, the “unit” is not limited to software or hardware. The “unit” may be configured to be on an addressable storage medium or to enable the execution of one or more processors. Thus, as an example, the “unit” may include components, such as software components, object-oriented software components, class components, and task components, processes, functions, attributes, procedures, subroutines, segments of program code, drivers, firmware, microcode, circuits, data, databases, data structures, tables, arrays, and variables. The functions provided in the components and “units” may be combined into fewer components and “units”, or further divided into more components and “units”. Additionally, the components and “units” may be implemented to execute one or more central processing units (CPUs) within a device or a secure multimedia card. Furthermore, in this embodiment, the “unit” may include one or more processors.

Hereinafter, the embodiments of the present invention will be described with reference to the drawings.

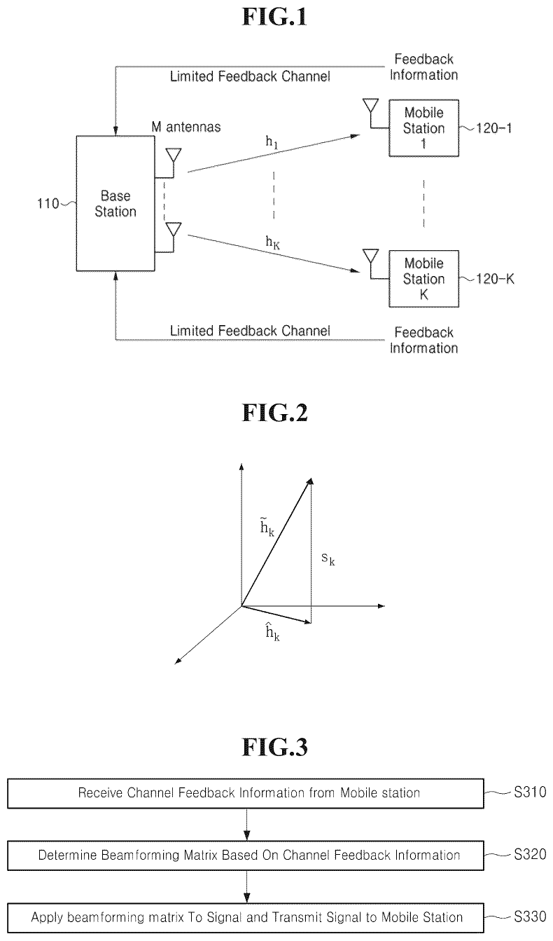

FIG. 1 is a diagram illustrating a wireless communication system based on a multi-user multiple-input single output (MU-MISO) according to an embodiment of the present invention.

Referring to FIG. 1, the MU-MISO system according to an embodiment of the present invention may include a base station (BS) 110 with M antennas and K (≤M) mobile stations (MS) (120-1, . . . , 120-K) each with a single antenna. The flat fading channel between the base station 110 and the k-th mobile station can be represented as hₖ∈ [symbol] ^{M×1}. Here, [symbol] represents the set of complex numbers, and in the example of FIG. 1, the channel between the base station 110 with M antennas and the mobile station with a single antenna can be expressed as an M×1 vector where each element has a complex value.

Unless otherwise defined in the following description of the present invention, the term “base station” refers to the base station 110 with M antennas that communicates with K mobile stations 120-1, . . . , 120-K each with a single antenna. Moreover, unless otherwise defined in the following description of the present invention, the term “mobile station” refers to the k-th mobile station, and the description will be provided with respect to parameters related to the k-th mobile station. However, it should be noted that the description of the present invention can equally apply to any mobile station in the system corresponding to k=1, 2, . . . , K, without loss of generality.

In the communication system illustrated in FIG. 1, the base station can apply a beamforming technique to transmit signals to the K mobile stations 120-1, . . . , 120-K. In the following description of the present invention, the signal to be transmitted by the base station is denoted as d=[d], . . . , dₖ]^{T}, and the beamforming matrix used for applying the beamforming technique is denoted as P=[p₁, . . . , P_{K}]. In this case, the signal x actually transmitted by the base station 110 can be expressed as shown in Equation 1 below:

$$x = {\sum }_{j = 1}^{K} {p}_{j} {d}_{j} \qquad [ Equation 1 ]$$

As shown in Equation 1, the signal x actually transmitted by the base station can be received at each mobile station along with noise nₖ through the channel hₖ between the base station and the mobile station. Therefore, the signal yₖ received by the k-th mobile station can be expressed as shown in Equation 2 below. In Equation 2, hₖ^{H} represents the Hermitian matrix of the channel hₖ, which is obtained by first taking the transpose matrix obtained by exchanging its row and column components of hₖ and then taking the complex conjugate of each component. Unless otherwise defined in the following description of the present invention, A^{H} for any matrix or vector A may represent the Hermitian matrix of A.

$${y}_{k} = {h}_{k}^{H} {\sum }_{j = 1}^{K} {p}_{j} {d}_{j} + {n}_{k} \qquad [ Equation 2 ]$$

The mobile station can estimate the signal that the base station actually intended to transmit by applying the receive filter gₖ to the received signal yₖ. Therefore, the signal dₖ estimated for the signal dₖ by the mobile station that the base station intended to transmit to the mobile station can be expressed as shown in Equation 3 below:

$${\hat{d}}_{k} = {g}_{k} ( {h}_{k}^{H} {\sum }_{j = 1}^{K} {p}_{j} {d}_{j} + {n}_{k} ) \qquad [ Equation 3 ]$$

Meanwhile, the data rate Rk of the k-th mobile station for the signal transmitted by the base station can be defined as shown in Equation 4 below. In Equation 4, σ₂² represents the noise component.

$${R}_{k} = {log}_{2} ( 1 + \frac{{\vert {h}_{k}^{H} {p}_{k} \vert}^{2}}{{\sum }_{j \neq k}^{K} {\vert {h}_{k}^{H} {p}_{k} \vert}^{2} + {σ}_{n}^{2}} ) \qquad [ Equation 4 ]$$

When the weight for the k-th mobile station is represented as μₖ, the weighted sum-rate (WSR) of the data rates for the K mobile stations that make up the system can be defined as shown in Equation 5 below:

$$\begin{matrix}{max}_{P} {\sum }_{k = 1}^{K} {μ}_{k} {R}_{k} \\ s . t . Tr ( {PP}^{H} ) \leq ρ\end{matrix} \qquad [ Equation 5 ]$$

In Equation 5, Tr(PP^{H})≤ρ represents the constraint on the transmission power limit of the base station. μₖ is the weight for the k-th mobile station, and Rx represents the data rate of the k-th mobile station, as defined in Equation 4. Tr(PP^{H}) is a function defined as the sum of the main diagonal components of PP^{H}. Unless otherwise defined in the following description of the present invention, Tr(A) for any matrix or vector A represents a function defined as the sum of the main diagonal components of A.

In the following description of the present invention, a method for determining a beamforming matrix P=[p₁, . . . , P_{K}] that maximizes the WSR of the mobile stations that make up the system, as defined by Equation 5, is disclosed. At this point, the optimization problem of finding P, which is the condition for the optimal solution that maximizes the WSR using Equation 5, is an NP-hard problem. However, it is known that the objective function defined by Equation 5 has the same gradient with respect to P as the objective function defined by Equation 6 below, and thus both have the same optimal solution under the same conditions.

$$\begin{matrix}{max}_{P} Tr ( W ℳ ) \\ s . t . Tr ( {PP}^{H} ) \leq ρ\end{matrix} \qquad [ Equation 6 ]$$

In Equation 6, [symbol] is the minimum mean square error (MMSE) matrix, defined as

$$ℳ = diag \{ {ℳ}_{1}^{MMSE} , … , {ℳ}_{K}^{MMSE} \} ,$$

where each

$${ℳ}_{k}^{MMSE}$$

represents the minimum value of the mean square error (MSE) [symbol] ₖ= [symbol] {(dₖ−\hat{d}ₖ)(dₖ−\hat{d}ₖ)^{H}} between the signal dₖ that the base station intends to transmit to the k-th mobile station and the signal \hat{d}ₖ estimated by the k-th mobile station. W=diag{w₁, . . . , w_{K}},

$${w}_{k} = {μ}_{k} / {ℳ}_{k}^{MMSE}$$

is the weight matrix that reflects the weight μₖ for each mobile station.

As explained earlier, it is known that Equation 6 has the same optimal solution under the same conditions as Equation 5. Therefore, finding the beamforming matrix P that maximizes the WSR in Equation 5 can be achieved by finding P, which is the condition for the optimal solution in Equation 6, defined through the weighted MMSE (WMMSE) between d and \hat{d}.

The signal \hat{d}ₖ, estimated by the mobile station for the signal dₖ that the base station intends to transmit, depends on the channel hₖ between the base station and the mobile station as shown in Equation 3. Equation 6 is defined through the WMMSE between d and \hat{d}, and therefore, in order to find P that has the optimal solution of Equation 6, the base station needs to identify the channel conditions between the base station and the mobile station as accurately as possible.

However, in general, the accurate channel state for the channel through which the base station transmits signals to the mobile station can only be identified at the mobile station, where the actual channel is measured by receiving the signal from the base station. After measuring the channel, the mobile station feeds back the channel state to the base station through channel state information, and the base station can identify the channel between the base station and the mobile station based on the channel state information fed back from the mobile station. However, while there are an infinite number of possible channel states between the base station and the mobile station, the number of bits that the mobile station can use to feed back the channel state to the base station is limited. As a result, the mobile station faces limitations in providing accurate channel state information by considering all possible channel states between the base station and the mobile station.

Therefore, in the present invention, a limited number of channel states are predefined between the mobile station and the base station, and one of these predefined channel states is selected and fed back using codebook-based channel feedback, which is referred to as limited feedback.

In the description of the present invention, each of the finite number of channel states predefined between the mobile station and the base station is referred to as a codeword, and the codebook refers to the set of predefined codewords. In a limited feedback-based system, the base station and the mobile station agree in advance on the codebook and the codewords that make up the codebook, allowing the mobile station to select a codeword that represents the channel state most similar to the actually measured channel state from the predefined codewords and feed it back to the base station. The process of selecting one of the predefined codewords to feed back the channel state is called quantization.

It is assumed that the mobile station and the base station know a predefined codebook C={c₁, . . . , c₂B}. In the description of the present invention, each of the codewords c₁, . . . , C₂B that make up the codebook is defined as a vector having a unit norm for representing the channel state. B represents the number of bits that the mobile station uses to feed back the channel state to the base station, and the mobile station can use these B bits to select one of 2^{B} codewords and feed it back to the base station. For example, if the value of B is 3 (i.e., if the mobile station feeds back the channel state to the base station using 3 bits), the bit value “000” may be predetermined to correspond to c₁, the bit value “001” may be predetermined to correspond to c₂, . . . , and the bit value 111 may be predetermined to correspond to C₂3. As another example, if the value of B is 5 (i.e., if the mobile station feeds back the channel state to the base station using 5 bits), the bit value “00000” may be predetermined to correspond to c₁, the bit value “00001” may be predetermined to correspond to c₂, . . . , and the bit value 11111 may be predetermined to correspond to C₂5.

After measuring the channel state of the downlink between the base station and the mobile station, the mobile station may determine the codeword cᵢ_{ₖ} that represents the channel state most similar to the actually measured channel state hₖ from the codewords c₁, . . . , C₂^{B} that make up the predefined codebook C, and then feed back the bit value corresponding to the determined cᵢ_{ₖ} to the base station.

In an embodiment of the present invention, each codeword cⱼ has a unit norm and is thus defined as a vector in a specific direction. Therefore, the mobile station can determine the codeword cⱼ through Equation 7 by using the inner product between hₖ and c; so that the codeword c; with the most similar direction to channel hₖ is selected.

$${i}_{k} = arg {max}_{j = 1 , … , {2}^{B}} {\vert {h}_{k}^{H} {c}_{j} \vert}^{2} \qquad [ Equation 7 ]$$

Meanwhile, as explained earlier, while there may be an infinite number of possible channel states between the base station and the mobile station, the information fed back from the mobile station to the base station is selected from a finite set of pre-agreed codewords, and thus cannot fully represent the exact channel state. Therefore, there may be a certain error between the actual channel and the fed-back channel quantized based on the codeword. This is referred to as a quantization error. In existing beamforming techniques, the beamforming matrix is designed based on the channel fed back from the mobile station, and thus, these techniques cannot sufficiently compensate for the quantization error that exists between the actual channel and the fed-back channel.

FIG. 2 is a diagram illustrating the quantization error between the actual channel and the fed-back channel in a limited feedback system according to an embodiment of the present invention.

Referring to FIG. 2, in a limited feedback-based system, there is a quantization error between the actual channel hₖ and the fed-back channel hₖ, and therefore, the actual channel hₖ can be decomposed into an hₖ component in the direction of the fed-back codeword and a quantization error sₖ component that is orthogonal to hₖ, as illustrated in FIG. 2. This can be expressed mathematically as shown in Equation 8.

In Equation 8, αₖ represents the amplitude of the ĥₖ component, and βₖ represents the amplitude of the sₖ component.

$$\begin{matrix}{h}_{k} = \sqrt{1 - {z}_{k}} {\hat{h}}_{k} + \sqrt{{z}_{k}} {s}_{k} \\ = {α}_{k} {\hat{h}}_{k} + {β}_{k} {s}_{k} \\ where {z}_{1} = 1 - {\vert {h}_{k}^{H} {\hat{h}}_{k} \vert}^{2}\end{matrix} \qquad [ Equation 8 ]$$

In existing beamforming techniques, the beamforming matrix is designed based on the channel ĥₖ fed back from the mobile station through codewords, and thus, these techniques cannot sufficiently compensate for the quantization error sₖ component. As a result, there are limitations in beamforming performance. The present invention proposes a method for designing a WMMSE beamforming matrix that is robust to channel errors and improves performance compared to existing technologies by compensating for the quantization error component sₖ.

To this end, the present invention contemplates a codebook defined by random vector quantization (RVQ). RVQ is a method of defining a codebook by randomly generating codewords that make up the codebook. According to RVQ, 2^{B} codewords c₁, . . . , C₂^{B} with a unit norm are randomly generated to form a codebook C, depending on the number of bits B that the mobile station can use for channel feedback.

If the codebook is defined based on RVQ in this manner, the amplitude αₖ of the ĥₖ component and the amplitude βₖ of the sₖ component in Equation 8 exhibit the statistical characteristics shown in Equation 9 below:

$$α = \sqrt{𝔼 \{ {α}_{k} \}} = \sqrt{M - ( M - 1 ) δ} β = \sqrt{𝔼 \{ {β}_{k} \}} = \sqrt{( M - 1 ) δ} \qquad [ Equation 9 ]$$

In Equation 9, 8 is a parameter that depends on the number of antennas M of the base station and the number of channel feedback bits B, and is defined as δ=2^{-B/(M-1)}

Likewise, if the codebook is defined based on RVQ, the covariance matrix of the quantization error sₖ exhibits the statistical characteristics shown in Equation [10] below:

$$𝔼 \{ {s}_{k} {s}_{k}^{H} \} = \frac{1}{M - 1} ( {I}_{M} - {\hat{h}}_{k} {\hat{h}}_{k}^{H} ) \qquad [ Equation 10 ]$$

Using the statistical characteristics of the codebook defined based on RVQ, represented in Equations 9 and 10, the term [symbol] ₖ, defined as the mean square error (MSE) of dₖ and \hat{d}ₖ, can be expressed as shown in Equation 11 below:

$$\begin{matrix}{ℳ}_{k} = 𝔼 \{ ( {d}_{k} - {\hat{d}}_{k} ) {( {d}_{k} - {d}_{k} )}^{H} \} \\ = {α}^{2} 𝔼 \{ {g}_{k} {h}_{k}^{H} {PP}^{H} {h}_{k} {g}_{k}^{H} \} + {β}^{2} \{ {g}_{k} {s}_{k}^{H} {PP}^{H} {s}_{k} {g}_{k}^{H} \} - α {p}_{k}^{H} {h}_{k} {g}_{k}^{H} - α {g}_{k} {h}_{k} {p}_{k} + {σ}_{n}^{2} {g}_{k} {g}_{k}^{H} + 1 \\ = M ( 1 - δ ) {g}_{k} {h}_{k}^{H} {PP}^{H} {h}_{k} {g}_{k}^{H} - α {p}_{k}^{H} {h}_{k} {g}_{k}^{H} - α {g}_{k} {h}_{k} {p}_{k} + ( δρ + {σ}_{n}^{2} ) {g}_{k} {g}_{k}^{H} + 1\end{matrix} \qquad [ Equation 11 ]$$

By differentiate Equation 11 with respect to gₖ* and calculate the gₖ value that satisfies

$$\frac{\partial }{\partial {g}_{k}^{*}} {ℳ}_{k} = 0$$

to find the value of the receiving filter gₖ that minimizes [symbol] ₖ, the receiving filter

$${g}_{k}^{MMSE}$$

that minimizes [symbol] ₖ can be calculated as shown in Equation 12 below:

$${g}_{k}^{MMSE} = α {p}_{k}^{H} {{h}_{k} ( M ( 1 - δ ) {h}_{k}^{H} {PP}^{H} {h}_{k} + δρ + {σ}_{n}^{2} )}^{- 1} \qquad [ Equation 12 ]$$

By substituting the receiving filter

$${g}_{k}^{MMSE}$$

calculated from Equation 12 into Equation 11, the minimum
value of [symbol] ₖ can be calculated as shown in Equation 13 below:

$$\text{?}$$

$$\text{?} \text{indicates text missing or illegible when filed}$$

$${ℳ}_{k}^{MMSE} = 1 - {α}^{2} {\hat{h}}_{k}^{H} {P}^{H} {{\hat{h}}_{k} ( M ( 1 - δ ) {\hat{h}}_{k}^{H} {PP}^{H} {h}_{k} + δρ + {σ}_{n}^{2} )}^{- 1}$$

At this time, as shown in Equation 11, the term [symbol] ₖ, which represents the MSE of dₖ and \hat{d}ₖ, includes the quantization error sₖ component, and it can be seen that the calculations of [symbol] ₖ and the subsequent

$${g}_{k}^{MMSE} and {ℳ}_{k}^{MMSE}$$

reflect the statistical characteristics of the covariance matrix sₖ as explained in Equation 10. That is, according to the channel error-robust WMMSE (hereinafter abbreviated as RWMMSE) technique proposed in the present invention, the parameters used to find the beamforming matrix P are designed to compensate for the quantization error sₖ component, and thus, it can be seen that this design enables improved beamforming performance compared to existing beamforming techniques.

Through the above description, the parameters

$$ℳ = diag \{ {ℳ}_{1}^{MMSE} , … , {ℳ}_{K}^{MMSE} \}$$

and W=diag{w₁, . . . , w_{K}},

$${w}_{k} = {μ}_{k} / {ℳ}_{k}^{MMSE}$$

that make up Equation 6 have been defined, and based on this, the present invention employs the Lagrange multiplier method to find the beamforming matrix P that has the optimal solution of Equation 6, using the objective function Tr(W [symbol] ) and the constraint Tr(PP^{H})≤ρ of Equation 6. Using the objective function and constraint of Equation 6, the Lagrange function L (P, G, Δ) can be defined as shown in Equation 14 below:

$$L ( P , G , λ ) = Tr ( W ℳ ) + λ ( Tr ( {PP}^{H} ) - ρ ) \qquad [ Equation 14 ]$$

Using the Lagrange function L(P, G, λ) defined in Equation 14, the beamforming matrix P that has the optimal solution of Equation 6 can be calculated as shown in Equation 15 below:

$$\begin{matrix}P = γ \overline{P} \\ where : \\ \overline{P} = {( {\hat{H}}^{H} {G}^{H} WG \hat{H} + \frac{( δρ + {σ}_{n}^{2} ) Tr ( {WGG}^{H} )}{M ( 1 - δ ) ρ} {I}_{M} )}^{- 1} {\hat{H}}^{H} {G}^{H} W \\ G = diag \{ {g}_{1}^{MMSE} , … , {g}_{k}^{MMSE} \} \\ γ = \sqrt{ρ / Tr ( \overline{P} {\overline{P}}^{H} )} \overline{P}\end{matrix} \qquad [ Equation 15 ]$$

As explained earlier, Equation 6 defined based on WMMSE has the same optimal solution under the same conditions as Equation 5 defined based on WSR. Therefore, the beamforming matrix P of Equation 15, which is determined to have the optimal solution of Equation 6, corresponds to the beamforming matrix that can maximize the WSR of the system. Moreover, the beamforming matrix P of Equation 15 has been calculated using parameters designed to compensate for quantization error components that occur in a limited feedback environment, according to the RWMMSE technique proposed in the present invention. Therefore, it can achieve a significantly higher sum-rate performance compared to existing beamforming techniques that did not consider quantization errors.]

FIG. 3 is a flowchart illustrating the operation of a base station according to an embodiment of the present invention.

Referring to FIG. 3, at step 310, the base station may receive channel feedback information from the mobile station. The channel feedback information received from the mobile station may be received in a limited feedback-based system and may consist of information generated based on a codebook and codewords predefined between the base station and the mobile station. At this time, the codebook and codewords predefined between the base station and the mobile station can be defined based on random vector quantization (RVQ).

At step 320, the base station may determine the beamforming matrix P that maximizes the weighted sum-rate (WSR) of the data rates of the mobile stations that make up the system. According to various embodiments of the present invention described above, the beamforming matrix P that maximizes the weighted sum-rate (WSR) can be determined through the optimization of the weighted minimum mean square error (WMMSE), taking into account the quantization error components in a limited feedback environment.

At step 330, the base station may apply the determined beamforming matrix P to a signal to be transmitted and transmit the signal to the mobile stations that make up the system.

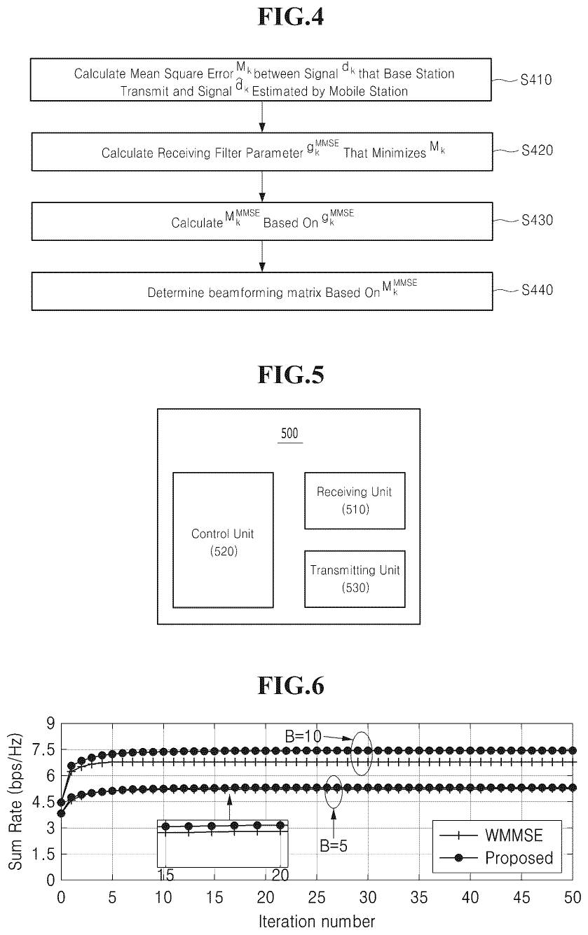

FIG. 4 is a flowchart illustrating a method for a base station to determine a beamforming matrix according to an embodiment of the present invention.

Referring to FIG. 4, at step 410, the base station may calculate a mean square error (MSE) [symbol] ₖ between a signal dₖ that the base station intends to transmit and a signal \hat{d}ₖ estimated by the mobile station. In one embodiment of the present invention, [symbol] ₖ can be calculated to reflect the quantization error components in a limited feedback environment based on the statistical characteristics of the codebook generated based on RVQ.

At step 420, the base station may calculate a receiving filter parameter

$${g}_{k}^{MMSE}$$

that minimizes [symbol] ₖ. In one embodiment of the present invention,

$${g}_{k}^{MMSE}$$

can be calculated as gₖ value that satisfies

$$\frac{\partial }{\partial {g}_{k}^{*}} {ℳ}_{k} = 0$$

for [symbol] calculated in step 410.

At step 430, the base station may calculate

$${ℳ}_{k}^{MMSE} ,$$

which is the minimum value of [symbol] ₖ, based on

$${g}_{k}^{MMSE} .$$

In one embodiment of the present invention

$${ℳ}_{k}^{MMSE}$$

can be calculated by substituting the receiving filter parameter

$${g}_{k}^{MMSE}$$

that minimizes [symbol] ₖ into [symbol] ₖ calculated in step 410.

At step 440, the base station may determine the final beamforming matrix P according to the embodiments of the present invention based on

$${ℳ}_{k}^{MMSE}$$

for each k.

FIG. 5 is a diagram illustrating the configuration of a base station apparatus according to an embodiment of the present invention.

Referring to FIG. 5, the base station apparatus 500 according to an embodiment of the present invention may include a receiving unit 510, a control unit 520, and a transmitting unit 530. However, the components of the base station are not limited to those mentioned above. For example, the base station may include more components (e.g., memory, etc.) or fewer components than those mentioned above.

The receiving unit 510 may receive various signals or information from the mobile stations that make up the system. In one embodiment of the present invention, the receiving unit 510 may be configured to receive channel feedback information transmitted from the mobile stations and transmit the received channel feedback information to the control unit.

The control unit 520 may control the overall configuration of the base station, including the receiving unit 510 and the transmitting unit 530, to ensure that the base station operates according to various embodiments of the present invention described above. In one embodiment of the present invention, the control unit 520 may determine a beamforming matrix that maximizes the weighted sum-rate (WSR) using the channel feedback information transmitted from the receiving unit 510. Moreover, the control unit 520 may perform the necessary operations to determine the beamforming matrix that maximizes the WSR according to various embodiments of the present invention described above.

The transmitting unit 530 may transmit various signals or information to the mobile stations that make up the system. In one embodiment of the present invention, the transmitting unit 530 may transmit signals to which the beamforming matrix that maximizes the WSR is applied to the mobile stations that make up the system.

The aforementioned channel error-robust WMMSE beamforming algorithm (RWMMSE) of the present invention can be expressed as shown in Table 1 below:

TABLE 1

```
Robust Weighted MMSE Beamforming Algorithm
Set n = 1 and initialize Pₙ = P⁰
repeat
  Compute Gₙ |Pₙ
  Compute Wₙ |Pₙ
  Compute Pₙ |Gₙ, Wₙ
  Set n ← n + 1
Until convergence
```

FIGS. 6 to 8 illustrate the convergence of the RWMMSE beamforming algorithm according to an embodiment of the present invention and the comparison results with other beamforming algorithms based on simulations. In the simulations, the number of antennas at the base station is set to M=4, the number of mobile stations is set to K=4. Moreover, two different quantification levels for the number of bits in the channel feedback information are considered, namely, B=5 and B=10. Without loss of generality, the initial beamforming matrix has been selected as a matched filter, and the algorithm's stopping criterion has been set to a predetermined number of iterations (e.g., 20). FIG. 6 is a diagram illustrating the ergodic convergence of the RWMMSE beamforming algorithm according to an embodiment of the present invention.

Specifically, FIG. 6 illustrates the ergodic convergence of the existing WMMSE beamforming algorithm and the RWMMSE beamforming algorithm proposed in the present invention when the signal noise ratio (SNR) is 10 dB. Referring to FIG. 6, it can be observed that the RWMMSE beamforming algorithm proposed in the present invention exhibits similar convergence to the existing WMMSE beamforming algorithm at both B=5 and B=10.

FIG. 7 is a diagram illustrating an example of the comparison of sum rate performance between the RWMMSE beamforming algorithm according to an embodiment of the present invention and a conventional beamforming algorithm.

Specifically, FIG. 7 illustrates the sum rate performance of various beamforming methods when the channel feedback bit count is B=5. The results are based on 5,000 simulations for each algorithm using the Monte Carlo method. As illustrated in FIG. 7, when B=5, it can be observed that the RWMMSE beamforming algorithm proposed in the present invention demonstrates superior sum-rate performance compared to the existing Regularized Zero Forcing (RZP) beamforming algorithm, Robust MMSE (RMMSE) beamforming algorithm, and Weighted MMSE (WMMSE) beamforming algorithm.

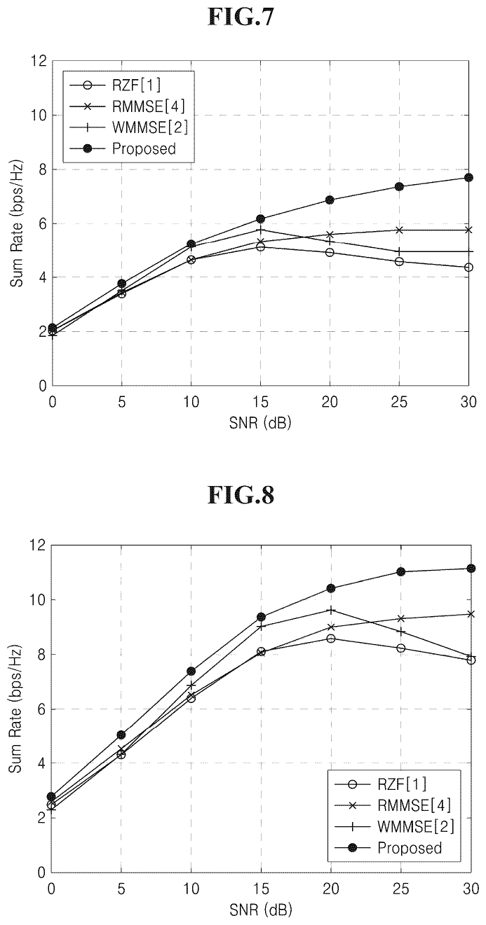

FIG. 8 is a diagram illustrating another example of the comparison of sum rate performance between the RWMMSE beamforming algorithm according to an embodiment of the present invention and a conventional beamforming algorithm.

Specifically, FIG. 8 illustrate the sum rate performance of various beamforming methods when the channel feedback bit count is B=10. The results are based on 5,000 simulations for each algorithm using the Monte Carlo method. As illustrated in FIG. 8, when B=10, it can be observed that the RWMMSE beamforming algorithm proposed in the present invention demonstrates superior sum-rate performance compared to the existing Regularized Zero Forcing (RZP) beamforming algorithm, Robust MMSE (RMMSE) beamforming algorithm, and Weighted MMSE (WMMSE) beamforming algorithm.

In the specific embodiments of the present disclosure described above, the components included in the disclosure are expressed in singular or plural forms depending on the specific embodiment presented. However, the use of singular or plural representations is merely for convenience of description and is selected to suit the contexts. This disclosure is not limited to the singular or plural components. Further, the component expressed in the plural form may also imply the singular form, and vice versa.

Meanwhile, although the detailed description of the present disclosure has provided specific embodiments, it is evident that various modifications are possible without departing from the scope of the present disclosure. Therefore, the scope of the present disclosure should not be limited to the described embodiments, but should be defined not only by the scope of the claims set forth below but also by their equivalents.

1. A method for transmitting signals from a base station in a communication system, the method comprising the steps of:
receiving, from a mobile station, channel feedback information generated based on a channel between the base station and the mobile station;
determining a beamforming matrix that maximizes the weighted sum rate (WSR) using the channel feedback information; and
transmitting a signal to the mobile station based on the beamforming matrix,
wherein the channel between the base station and the mobile station consists of a first component corresponding to the channel feedback information and a second component corresponding to a quantization error, and
wherein the beamforming matrix is determined based on the second component corresponding to the quantization error.

2. The method according to claim 1, wherein the step of determining a beamforming matrix comprises the steps of:
calculating a mean square error (MSE) [symbol] ₖ between a signal dₖ that the base station transmits and a signal \hat{d}ₖ estimated for the signal dₖ by the mobile station;
calculating a receiving filter parameter
$${g}_{k}^{MMSE}$$
that minimizes the MSE between the dₖ and \hat{d}ₖ;
calculating a minimum mean square error (MMSE)
$${ℳ}_{k}^{MMSE}$$
between dₖ and \hat{d}ₖ based on the receiving filter
$${g}_{k}^{MMSE} ;$$
and
determining the beamforming matrix based on the
$${ℳ}_{k}^{MMSE} .$$

3. The method according to claim 2, wherein the [symbol] ₖ is calculated based on the statistical characteristics associated with the first component corresponding to the channel feedback information and a second component corresponding to the quantization error.

4. The method according to claim 1, wherein the channel feedback information is received based on a codebook predefined between the base station and the mobile station.

5. The method according to claim 4, wherein the codebook is defined based on random vector quantization (RVQ).

6. The method according to claim 1, wherein an expected value of the amplitude of the first component and an expected value of the amplitude of the second component are determined based on the number of antennas of the base station and the number of bits of the channel feedback information.

7. The method according to claim 1, wherein a covariance matrix of the second component is determined based on the number of antennas of the base station.

8. The method according to claim 1, wherein the base station has a plurality of antennas, and the mobile station has a single antenna.

9. A base station apparatus for transmitting signals in a communication system, the base station apparatus comprising:
a receiving unit for receiving, from a mobile station, channel feedback information generated based on a channel between a base station and the mobile station;
a control unit for determining a beamforming matrix that maximizes the weighted sum rate (WSR) using the channel feedback information; and
a transmitting unit for transmitting a signal to the mobile station based on the beamforming matrix,
wherein the channel between the base station and the mobile station consists of a first component corresponding to the channel feedback information and a second component corresponding to a quantization error, and
wherein the beamforming matrix is determined based on the second component corresponding to the quantization error.

10. The base station apparatus according to claim 9, wherein the control unit is configured to:
calculate a mean square error (MSE) [symbol] ₖ between a signal dₖ that the base station transmits and a signal \hat{d}ₖ estimated for the signal dₖ by the mobile station;
calculate a receiving filter parameter
$${g}_{k}^{MMSE}$$
that minimizes the MSE between the dₖ and \hat{d}ₖ;
calculate a minimum mean square error (MMSE)
$${ℳ}_{k}^{MMSE}$$
between dₖ and \hat{d}ₖ based on the receiving filter
$${g}_{k}^{MMSE} ;$$
and
determine the beamforming matrix based on the
$${ℳ}_{k}^{MMSE} .$$

11. The base station apparatus according to claim 10, wherein the [symbol] ₖ is calculated based on the statistical characteristics associated with the first component corresponding to the channel feedback information and a second component corresponding to the quantization error.

12. The base station apparatus according to claim 9, wherein the channel feedback information is received based on a codebook predefined between the base station and the mobile station.

13. The base station apparatus according to claim 12, wherein the codebook is defined based on random vector quantization (RVQ).

14. The base station apparatus according to claim 9, wherein an expected value of the amplitude of the first component and an expected value of the amplitude of the second component are determined based on the number of antennas of the base station and the number of bits of the channel feedback information.

15. The base station apparatus according to claim 9, wherein a covariance matrix of the second component is determined based on the number of antennas of the base station.

16. The base station apparatus according to claim 9, wherein the base station has a plurality of antennas, and the mobile station has a single antenna.
